(19) United States
(12) Patent Application Publication
(10) Pub. No.: US 2020/0063892 A1
(43) Pub. Date: Feb. 27, 2020

(54) METHOD FOR PREDICTING VALVE LEAKAGE

(71) Applicant: Fujian Kailitong Technology Co., Ltd, Fuzhou (CN)

(72) Inventors: Zhenming KE, Fuzhou (CN); Junmin Liu, Fuzhou (CN); Qiu Lin, Fuzhou (CN)

(21) Appl. No.: 16/600,513

(22) Filed: Oct. 13, 2019

Related U.S. Application Data
(63) Continuation of application No. PCT/CN2018/081876, filed on Apr. 4, 2018.

(30) Foreign Application Priority Data
Apr. 14, 2017 (CN) 201710245677.5

(51) Int. Cl. F16K 37/00; G01M 3/28

(52) U.S. Cl. CPC F16K 37/0083; G01M 3/2876

(57) ABSTRACT

A method for predicting valve leakage, comprising following steps: 1) prefabricating a valve; 2) mounting, on the valve, a sensor (70) and a signal transmitter (90); 3) debugging the valve, measuring and determining a critical specific pressure of a sealing face, and preconfiguring the critical specific pressure into the signal transmitter (90); 4) detecting, by the sensor (70), the specific pressure of the sealing face in real time, and transmitting a specific pressure signal to the signal transmitter (90); and 5) comparing, the signal transmitter (90), the detected specific pressure of the sealing face with the critical specific pressure to determine whether the valve is about to leak, i.e., determining that the valve is well sealed and providing no alert when the detected specific pressure of the sealing face is greater than the critical specific pressure.

### CROSS-REFERENCE TO RELATED APPLICATIONS

This application is a continuation of International Patent Application No. PCT/CN2018/081876, filed on Apr. 4, 2018, which claims the benefit of priority from Chinese Patent Application No. 201710245677.5, filed on Apr. 14, 2017. The contents of the aforementioned application, including any intervening amendments thereto, are incorporated herein by reference in its entirety.

### TECHNICAL FIELD

The present invention relates to a method for predicting valve leakage, relating to the field of valves.

### BACKGROUND OF THE PRESENT INVENTION

Valve leakage often occurs when in use, due to material aging or abrasion of the sealing face. Usually, leakage is caused when the sealing face cannot be well fitted due to too low specific pressure. There are various instruments or means to detect leakage during the production in modern factories. However, those instruments or means are specific to detection after the occurrence of leakage. For example, although instruments such as ultrasonic leakage detectors and differential leakage detectors work well in the detection and repair of leakage in process pipelines, the valves have to be replaced or maintained once leakage occurs. In severe cases, accidents may be caused, leading to irreparable loss.

### SUMMARY OF THE PRESENT INVENTION

### Technical problems

It is difficult to detect tiny leakage of valves in special environments by the existing detection techniques, let alone to predict whether the valve is about to leak.

### Solutions to the Problems

### Technical Solutions

An objective of the present invention provides a method for predicting valve leakage, by whichwhether the valve is about to leak internally or externally can be predicted online. It is convenient for the maintenance personnel to take measures in time, thereby minimizing the accident loss.

A method for predicting valve leakage is provided, comprising following steps:

1) prefabricating a valve;

2) mounting, on the valve, a sensor and a signal transmitter;

3) debugging the valve, measuring and determining a critical specific pressure of a sealing face, and preconfiguring the critical specific pressure into the signal transmitter;

4) detecting, by the sensor, the specific pressure of the sealing face in real time, and transmitting a specific pressure signal to the signal transmitter; and

5) comparing, the signal transmitter, the detected specific pressure of the sealing face with the critical specific pressure to determine whether the valve is about to leak, and sending the result data to a monitoring system.

Further, the valve comprises a valve body, a valve seat and a valve core; a bearing, a spring, a stopper, a sensor and a pre-tensioner are sheathed, from the bottom up, on a valve stem of the valve core, which goes through the valve seat; both the inner sealing and the outer sealing of the valve are realized by the effective fitting of the valve core with the valve seat, and the effective fitting of the valve core with the valve seat is realized by pre-tensioning the valve steam by the pre-tensioner.

Further, the sensor is a pressure sensor that is annular and has a center aperture greater than the diameter of the valve stem; a pressure-bearing stage, arranged on an upper end face of the sensor, is higher than the annular edge of the sensor and comes into contact with a lower end face of the pre-tensioner; the sensor detects the specific pressure of the sealing face by detecting the pressure at the pre-tensioner.

Further, the signal transmitter comprises an MCU processor, an IOT module and a display window; the signal transmitter is annular, and is sheathed on the pre-tensioner by a central through-hole and electrically connected to the sensor to realize signal transmission with the monitoring system by an NB-IOT network and a cloud data platform.

Further, the sensor detects the specific pressure of the sealing face in real time and electrically sends the specific pressure to the signal transmitter; the signal transmitter compares the specific pressure of the sealing face with the preconfigured critical specific pressure, i.e., determines that the valve is well sealed and provides no alert when the detected specific pressure of the sealing face is greater than the critical specific pressure, and determines that the valve is about to leak and provides an alert when the detected specific pressure of the sealing face is reduced to the critical specific pressure. And, the monitoring system predicts whether the valve is about to leak.

Beneficial Effects

The method of predicting valve leakage by detecting the specific pressure of the sealing face of the valve is simple and straightforward, and is applicable to different valves. By sheathing the sensor on the valve stem outside the medium channel without coming into contact with the medium, it realizes both compact structure and reliable operation and convenient maintenance. By online detection and prediction before leakage, it is convenient for maintenance personnel to tighten the pre-tensioner of the valve core online, in order to return to normal sealed operation of the valve and effectively prolong the service life of the valve. Leakage is avoided, accidents are avoided in advance, and the operating cost of enterprises is reduced significantly.

### BRIEF DESCRIPTION OF THE DRAWINGS

FIG. 1 is a schematic diagram of the working principle of the present invention; and

FIG. 2 is a structural diagram of the valve of the present invention.

### REFERENCE NUMERALS

10: valve body; 20: valve seat; 30: valve core; 40: bearing; 50: spring; 60: stopper; 70: sensor; 80: pre-tensioner; 90: signal transmitter.

### DETAILED DESCRIPTION OF THE PRESENT INVENTION

To make the above features and advantages of the present invention more clear, the present invention will be described below in detail with reference to the accompanying drawings by specific embodiments. However, the present invention is not limited thereto.

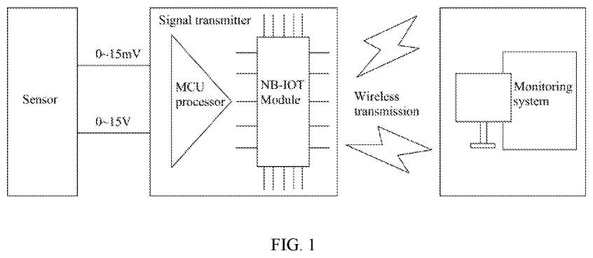

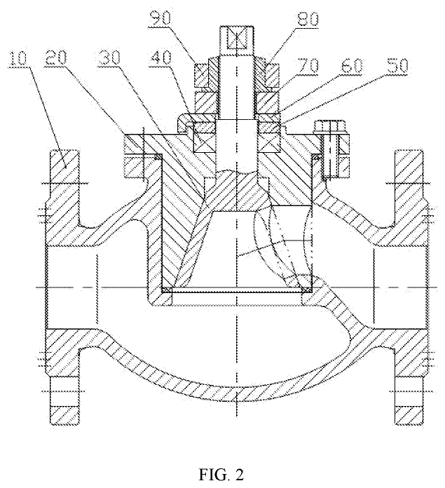

Referring to FIGS. 1 and 2, a method for predicting valve leakage is provided, comprising following steps:

1) prefabricating a valve;

2) mounting, on the valve, a sensor 70 and a signal transmitter 90;

3) debugging the valve, measuring and determining a critical specific pressure of a sealing face, and preconfiguring the critical specific pressure into the signal transmitter;

4) detecting, by the sensor, the specific pressure of the sealing face in real time, and transmitting a specific pressure signal to the signal transmitter; and

5) comparing, the signal transmitter, the detected specific pressure of the sealing face with the critical specific pressure to determine whether the valve is about to leak, and sending the result data to a monitoring system.

In this embodiment, the valve comprises a valve body 10, a valve seat 20 and a valve core 30. An inlet channel, an outlet channel, and a vertical round hole that is perpendicular to a centerline of the channel are formed on the valve body. The valve seat is mounted in the vertical round hole of the valve body, having: a valve seat cavity formed in its lower portion, a vertical through-hole, which is coaxial to the valve seat cavity, formed in its upper portion, and a horizontal through-hole formed on its side. The valve core is mounted in the valve seat cavity, having: a valve stem going through the vertical through-hole of the valve seat formed in its upper portion, a frustum fitted with the valve seat cavity formed in its lower portion, and a frustum through-hole formed on its side. A frustum cavity is formed below the frustum. A bearing 40, a spring 50, a stopper 60 and a sensor 70 are successively sheathed, from the bottom up, on the valve stem which goes through the vertical through-hole. The signal transmitter 90 is sheathed on the pre-tensioner and electrically connected to the sensor.

In this embodiment, both the inner sealing and the outer sealing of the valve are realized by the effective fitting of the valve core with the valve seat. The specific pressure of the sealing face directly corresponds to the pressure at the pre-tensioner. The sealing effect is determined by the detection of the pressure at the pre-tensioner. There is a critical specific pressure at the sealing face. The effective fitting of the valve core with the valve seat is realized by pre-tensioning the valve steam by the pre-tensioner.

In this embodiment, the sensor is a pressure sensor that is annular and has a center aperture slightly greater than the diameter of the valve stem. A pressure-bearing stage, arranged on an upper end face of the sensor, is higher than the annular edge of the sensor and comes into contact with a lower end face of the pre-tensioner. The sensor detects the specific pressure of the sealing face by detecting the pressure at the pre-tensioner. The sensor electrically sends the specific pressure to the signal transmitter 90 by 0-15V power, to output a 0-15 mV specific pressure signal.

In this embodiment, the signal transmitter comprises an MCU processor, an IOT module and a display window. The signal transmitter is annular, and is sheathed on the pre-tensioner by a central through-hole and electrically connected to the sensor to realize signal transmission with the monitoring system by an NB-IOT network and a cloud data platform. When assembling the valve, by the display window, the change in the specific pressure of the sealing face can be observed and the critical specific pressure can be determined, and also the specific pressure of the sealing face can be further accurately increased by tightening the pre-tensioner in order to meet the sealing requirements of practical production.

In this embodiment, the sensor detects the specific pressure of the sealing face in real time and electrically sends the specific pressure to the signal transmitter. The signal transmitter compares the specific pressure of the sealing face with the preconfigured critical specific pressure, i.e., determines that the valve is well sealed and provides no alert when the detected specific pressure of the sealing face is greater than the critical specific pressure, and determines that the valve is about to leak and provides an alert when the detected specific pressure of the sealing face is reduced to the critical specific pressure. And, the monitoring system predicts whether the valve is about to leak. The maintenance personnel is notified to lock the valve core again by the pre-tensioner, thus to return to normal sealed operation of the valve.

The above description is merely a preferred embodiment of the present invention. The method of predicting valve leakage by detecting the specific pressure of the sealing face is applicable to other valves. Without departing from the principle and spirit of the present invention, any equivalent changes, modifications, replacements and variations made within the patent scope of the present invention shall fall into the protection scope of the present invention.

1. A method for predicting valve leakage, comprising following steps:
1) prefabricating a valve;
2) mounting, on the valve, a sensor and a signal transmitter;
3) debugging the valve, measuring and determining a critical specific pressure of a sealing face, and preconfiguring the critical specific pressure into the signal transmitter;
4) detecting, by the sensor, the specific pressure of the sealing face in real time, and transmitting a specific pressure signal to the signal transmitter; and
5) comparing, the signal transmitter, the detected specific pressure of the sealing face with the critical specific pressure to determine whether the valve is about to leak, and sending the result data to a monitoring system.

2. The method for predicting valve leakage according to claim 1, wherein the valve comprises a valve body, a valve seat and a valve core; a bearing, a spring, a stopper, a sensor and a pre-tensioner are successively sheathed, from the bottom up, on a valve stem of the valve core, which goes through the valve seat; both the inner sealing and the outer sealing of the valve are realized by the effective fitting of the valve core with the valve seat, and the effective fitting of the valve core with the valve seat is realized by pre-tensioning the valve steam by the pre-tensioner.

3. The method for predicting valve leakage according to claim 2, wherein the sensor is a pressure sensor that is annular and has a center aperture greater than the diameter of the valve stem; a pressure-bearing stage, arranged on an upper end face of the sensor, is higher than the annular edge of the sensor and comes into contact with a lower end face of the pre-tensioner; the sensor detects the specific pressure of the sealing face by detecting the pressure at the pre-tensioner.

4. The method for predicting valve leakage according to claim 1, wherein the signal transmitter comprises an MCU processor, an IOT module and a display window; the signal transmitter is annular, and is sheathed on the pre-tensioner by a central through-hole and electrically connected to the sensor to realize signal transmission with the monitoring system by an NB-IOT network and a cloud data platform.

5. The method for predicting valve leakage according to claim 1, wherein the sensor detects the specific pressure of the sealing face in real time and electrically sends the specific pressure to the signal transmitter; the signal transmitter compares the specific pressure of the sealing face with the preconfigured critical specific pressure, i.e., determines that the valve is well sealed and provides no alert when the detected specific pressure of the sealing face is greater than the critical specific pressure, and determines that the valve is about to leak and provides an alert when the detected specific pressure of the sealing face is reduced to the critical specific pressure; and, the monitoring system predicts whether the valve is about to leak.

6. The method for predicting valve leakage according to claim 2, wherein the sensor detects the specific pressure of the sealing face in real time and electrically sends the specific pressure to the signal transmitter; the signal transmitter compares the specific pressure of the sealing face with the preconfigured critical specific pressure, i.e., determines that the valve is well sealed and provides no alert when the detected specific pressure of the sealing face is greater than the critical specific pressure, and determines that the valve is about to leak and provides an alert when the detected specific pressure of the sealing face is reduced to the critical specific pressure; and, the monitoring system predicts whether the valve is about to leak.

7. The method for predicting valve leakage according to claim 3, wherein the sensor detects the specific pressure of the sealing face in real time and electrically sends the specific pressure to the signal transmitter; the signal transmitter compares the specific pressure of the sealing face with the preconfigured critical specific pressure, i.e., determines that the valve is well sealed and provides no alert when the detected specific pressure of the sealing face is greater than the critical specific pressure, and determines that the valve is about to leak and provides an alert when the detected specific pressure of the sealing face is reduced to the critical specific pressure; and, the monitoring system predicts whether the valve is about to leak.

8. The method for predicting valve leakage according to claim 4, wherein the sensor detects the specific pressure of the sealing face in real time and electrically sends the specific pressure to the signal transmitter; the signal transmitter compares the specific pressure of the sealing face with the preconfigured critical specific pressure, i.e., determines that the valve is well sealed and provides no alert when the detected specific pressure of the sealing face is greater than the critical specific pressure, and determines that the valve is about to leak and provides an alert when the detected specific pressure of the sealing face is reduced to the critical specific pressure; and, the monitoring system predicts whether the valve is about to leak.
